(19) United States
(12) Patent Application Publication
(10) Pub. No.: US 2026/0128016 A1
(43) Pub. Date: May 7, 2026

(54) LIQUID CRYSTAL DISPLAY DEVICE

(71) Applicant: Sharp Display Technology Corporation, Kameyama City (JP)

(72) Inventor: Shinji Shimada, Kameyama City (JP)

(21) Appl. No.: 19/372,635

(22) Filed: Oct. 29, 2025

(30) Foreign Application Priority Data
Nov. 5, 2024 (JP) 2024-193698

(51) Int. Cl. G09G 3/36; G09G 3/00

(52) U.S. Cl. CPC G09G 3/3607; G09G 3/035; G09G 3/3614; G09G 3/3659; G09G 2300/0465; G09G 2320/0247; G09G 2320/0252

(57) ABSTRACT

A liquid crystal display device includes: a plurality of pixels arranged in a matrix of M rows and N columns; an array substrate including: first pixel electrodes being disposed respectively in the pixels; and M second pixel electrodes respectively located adjacent to M first pixel electrodes in a first column; and a controller configured to drive: liquid crystal molecules belonging to a pixel in an m-th row and a first column using an electric field formed between a first pixel electrode in the m-th row and the first column and a second pixel electrode located adjacent to the first pixel electrode; and liquid crystal molecules belonging to a pixel in the m-th row and an n-th column using an electric field formed between a first pixel electrode in the m-th row and the n-th column and a first pixel electrode in the m-th row and an (n−1)th column.

### CROSS-REFERENCE TO RELATED APPLICATIONS

The present application claims priority under 35 U.S.C. § 119 to Japanese Patent Application No. 2024-193698 filed on Nov. 5, 2024, the contents of which are incorporated herein by reference in their entirety.

### BACKGROUND OF THE INVENTION

### Field of the Invention

The following disclosure relates to liquid crystal display devices.

### Description of Related Art

In recent years, liquid crystal display panels for head-mounted displays (LCDs for HMDs) have been under development. LCDs for HMDs require high color reproduction in the peripheral region of the field of view, and therefore mainly employ liquid crystal display modes in which liquid crystal molecules move horizontally relative to the polarization surface, such as the in-plane switching (hereinafter, referred to as “IPS”) mode or the fringe field switching (hereinafter, referred to as “FFS”) mode. For example, JP 2005-37913 A and JP 2006-189758 A each disclose an example liquid crystal display device in the conventional IPS mode.

### SUMMARY

(1) One embodiment of the present invention is directed to a liquid crystal display device including: a plurality of pixels arranged in a matrix of M rows and N columns, wherein M and N are each an integer of 2 or greater; an array substrate including: a plurality of first pixel electrodes being disposed respectively in the plurality of pixels; and M second pixel electrodes respectively arranged adjacent to M first pixel electrodes in a first column among the plurality of first pixel electrodes, located on a side opposite to first pixel electrodes in a second column with respect to the first pixel electrodes in the first column in a row direction; a liquid crystal layer including liquid crystal molecules; and a controller configured to apply a predetermined voltage to the M second pixel electrodes and voltages based on video signals to the plurality of first pixel electrodes to drive: liquid crystal molecules belonging to a pixel in an m-th row and a first column, wherein m is an integer of 1 or greater and M or less, using an electric field formed between a first pixel electrode in the m-th row and the first column among the plurality of first pixel electrodes and a second pixel electrode located adjacent in the row direction to the first pixel electrode in the m-th row and the first column among the M second pixel electrodes; and liquid crystal molecules belonging to a pixel in the m-th row and an n-th column, wherein n is an integer of 2 or greater and N or less, using an electric field formed between a first pixel electrode in the m-th row and the n-th column and a first pixel electrode in the m-th row and an (n−1)th column among the plurality of first pixel electrodes.

(2) In an embodiment of the present invention, the liquid crystal display device includes the structure (1), and the controller is configured to determine the voltage to be applied to the first pixel electrode in the m-th row and the first column based on a gray scale value for display in the pixel in the m-th row and the first column using the predetermined voltage as a reference, and to determine the voltage to be applied to the first pixel electrode in the m-th row and the n-th column based on a gray scale value for display in the pixel in the m-th row and the n-th column using the voltage to be applied to the first pixel electrode in the m-th row and the (n−1)th column as a reference.

(3) In an embodiment of the present invention, the liquid crystal display device includes the structure (2), and when a maximum voltage applicable to the plurality of first pixel electrodes is defined as Aₘₐₓ(V), a minimum voltage applicable to the plurality of first pixel electrodes is defined as Aₘᵢₙ(V), a voltage that produces the gray scale value for display in the pixel in the m-th row and the n-th column is defined as Bₙ(V), a voltage to be applied to the first pixel electrode in the m-th row and the (n−1)th column is defined as Cₙ₋₁(V), and a voltage to be applied to the first pixel electrode in the m-th row and the n-th column is defined as Cₙ(V), the controller is configured to determine Cₙ(V) based on either one of the following equations (1) and (2) or either one of the following equations (3) and (4):

$$if {C}_{n - 1} + {B}_{n} \leq {A}_{max} , then {C}_{n} = {C}_{n - 1} + {B}_{n} \qquad Equation ( 1 )$$

$$if {C}_{n - 1} + {B}_{n} > {A}_{max} , then {C}_{n} = {C}_{n - 1} - {B}_{n} \qquad Equation ( 2 )$$

$$if {C}_{n - 1} - {B}_{n} \geq {A}_{min} , then {C}_{n} = {C}_{n - 1} - {B}_{n} \qquad Equation ( 3 )$$

$$if {C}_{n - 1} - {B}_{n} < {A}_{min} , then {C}_{n} = {C}_{n - 1} + {B}_{n} . \qquad Equation ( 4 )$$

(4) In an embodiment of the present invention, the liquid crystal display device includes the structure (2) or (3), and the controller is configured to drive the M second pixel electrodes and the first pixel electrode in the m-th row and the first column with an AC voltage by inverting a polarity of the predetermined voltage between a positive field and a negative field within a single frame.

(5) In an embodiment of the present invention, the liquid crystal display device includes the structure (3) or (4), and the controller is configured to drive the first pixel electrode in the m-th row and the n-th column with an AC voltage by determining Cₙ(V) during a positive field within a single frame based on either one of the equations (1) and (2) and determining Cₙ(V) during a negative field within the single frame based on either one of the equations (3) and (4).

(6) In an embodiment of the present invention, the liquid crystal display device includes the structure (1), (2), (3), (4), or (5), and a constant DC component is superimposed on each of the voltages to be applied to the plurality of first pixel electrodes.

(7) In an embodiment of the present invention, the liquid crystal display device includes the structure (1), (2), (3), (4), (5), or (6), and the second pixel electrodes have substantially a same shape as the first pixel electrodes.

(8) In an embodiment of the present invention, the liquid crystal display device includes the structure (1), (2), (3), (4), (5), (6), or (7), and the first pixel electrodes have a linear shape with no branched portion.

(9) In an embodiment of the present invention, the liquid crystal display device includes the structure (8), the array substrate further includes a source bus line to which the voltages based on the video signals are supplied, and an angle formed between a first direction in which a main portion including a central portion of each of the first pixel electrodes extends and a direction in which the source bus line extends is 15° or less.

(10) In an embodiment of the present invention, the liquid crystal display device includes the structure (8) or (9), the array substrate further includes a source bus line to which the voltages based on the video signals are supplied, the first pixel electrodes each include a main portion including a central portion thereof and extending in a first direction, and a bent portion connected to at least one of end portions of the main portion in the first direction and extending in a second direction, and an angle formed between the second direction and a direction in which the source bus line extends is greater than an angle formed between the first direction and the direction in which the source bus line extends.

(11) In an embodiment of the present invention, the liquid crystal display device includes the structure (1), (2), (3), (4), (5), (6), (7), (8), (9), or (10), and either or both of the first pixel electrodes and the second pixel electrodes include a light-shielding material.

(12) Another embodiment of the present invention relates to a liquid crystal display device including: a plurality of pixels arranged in a matrix of M rows and N columns, wherein M and N are each an integer of 2 or greater; an array substrate including: a plurality of first pixel electrodes being disposed respectively in the plurality of pixels; and M second pixel electrodes respectively arranged adjacent to M first pixel electrodes in a first column among the plurality of first pixel electrodes, located on a side opposite to first pixel electrodes in a second column with respect to the first pixel electrodes in the first column in a row direction; a liquid crystal layer including liquid crystal molecules; and a controller configured to apply a voltage to the M second pixel electrodes and voltages based on video signals to the plurality of first pixel electrodes to drive: liquid crystal molecules belonging to a pixel in an m-th row and a first column, wherein m is an integer of 1 or greater and M or less, using an electric field formed between a first pixel electrode in the m-th row and the first column among the plurality of first pixel electrodes and a second pixel electrode located adjacent in the row direction to the first pixel electrode in the m-th row and the first column among the M second pixel electrodes; and liquid crystal molecules belonging to a pixel in the m-th row and an n-th column, wherein n is an integer of 2 or greater and N or less, using an electric field formed between a first pixel electrode in the m-th row and the n-th column and a first pixel electrode in the m-th row and an (n−1)th column among the plurality of first pixel electrodes, the plurality of first pixel electrodes having a linear shape with no branched portion.

(13) In an embodiment of the present invention, the liquid crystal display device includes the structure (12), the array substrate further includes a source bus line to which the voltages based on the video signals are supplied, and an angle formed between a first direction in which a main portion including a central portion of each of the first pixel electrodes extends and a direction in which the source bus line extends is 15° or less.

(14) In an embodiment of the present invention, the liquid crystal display device includes the structure (12) or (13), the array substrate further includes a source bus line to which the voltages based on the video signals are supplied, the first pixel electrodes each include a main portion including a central portion thereof and extending in a first direction, and a bent portion connected to at least one of end portions of the main portion in the first direction and extending in a second direction, and an angle formed between the second direction and a direction in which the source bus line extends is greater than an angle formed between the first direction and the direction in which the source bus line extends.

(15) In an embodiment of the present invention, the liquid crystal display device includes the structure (12), (13), or (14), and either or both of the first pixel electrodes and the second pixel electrodes include a light-shielding material.

The present disclosure can provide a liquid crystal display device that enables a higher definition while maintaining a sufficient aperture ratio.

### BRIEF DESCRIPTION OF THE DRAWINGS

FIG. 1 is a schematic diagram showing the pixel structure of an IPS mode liquid crystal display device.

FIG. 2 is a schematic diagram showing the pixel structure of an FFS mode liquid crystal display device.

FIG. 3 is a schematic diagram showing the pixel structure of the liquid crystal display device of the present disclosure.

FIG. 4 is a plan view schematically showing the pixel structure of a liquid crystal display device of Embodiment 1.

FIG. 5 is a diagram schematically showing a cross section of an array substrate taken along the line A-A in FIG. 4.

FIG. 6 is a diagram showing the system configuration of the liquid crystal display device of Embodiment 1.

FIG. 7 is a plan view schematically showing the pixel structure of a liquid crystal display device of Example 2.

FIG. 8 is a plan view schematically showing a first pixel electrode that includes a bent portion in one of the end portions of the electrode.

FIG. 9 is a plan view schematically showing a first pixel electrode that includes bent portions in both of the end portions of the electrode.

### DETAILED DESCRIPTION OF THE INVENTION

In applications such as LCDs for HMDs, there is an increasing demand for a higher definition in liquid crystal panels, with recent display resolutions exceeding 1000 ppi and approaching 2000 ppi. However, in the conventional IPS mode and FFS mode, it has been difficult to increase the pixel aperture ratio (hereinafter, referred to simply as “aperture ratio”) or the maximum transmittance (mode efficiency) within the same aperture area, making it challenging to achieve sufficient transmittance in ultra-high-definition liquid crystal display devices.

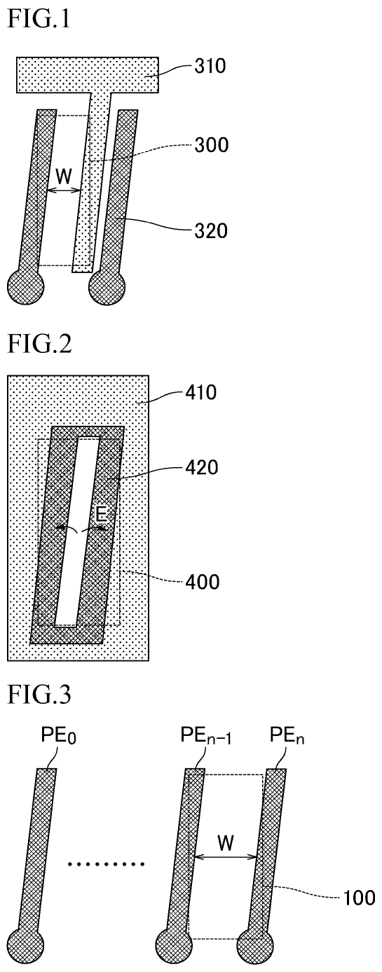

FIG. 1 is a schematic diagram showing the pixel structure of an IPS mode liquid crystal display device. As shown in the figure, in an IPS mode pixel, a pixel electrode 320 and a common electrode 310 are arranged on the same plane. In ultra-high-definition liquid crystal display devices, the width W of a portion actually used for display (a portion sandwiched between the pixel electrode 320 and the common electrode 310) in a display portion (optical opening) 300 cannot be increased due to the issues related to the processing accuracy, which makes it challenging to achieve sufficient transmittance.

FIG. 2 is a schematic diagram showing the pixel structure of an FFS mode liquid crystal display device. As shown in the figure, in an FFS mode pixel, a pixel electrode (upper layer electrode) 420 and a common electrode 410 overlap three-dimensionally, making the FFS mode more advantageous than the IPS mode in terms of processing accuracy. However, electric field lines E influence the liquid crystal molecules in a display portion 400 through the opening of the pixel electrode 420, causing the liquid crystal molecules to tilt also in the thickness direction of the cell. This makes it challenging to achieve sufficient mode efficiency.

In response to the above current state of the art, the present disclosure aims to provide a liquid crystal display device that enables a higher definition while maintaining a sufficient aperture ratio.

### Summary of the Present Disclosure

The liquid crystal display device of the present disclosure enables the liquid crystal molecules to move in a manner similar to those in IPS mode liquid crystal display devices, without using a common electrode. This approach significantly reduces the issues related to the pixel structure processing accuracy while significantly improving the aperture ratio (transmittance) and light utilization efficiency of ultra-high-definition LCDs for HMDs. FIG. 3 is a schematic diagram showing the pixel structure of the liquid crystal display device of the present disclosure. As shown in the figure, the liquid crystal display device of the present disclosure includes a second pixel electrode PE₀ and a plurality of first pixel electrodes PEₙ₋₁ and PEₙ arranged side by side within a display region. A common electrode may not be provided. The liquid crystal molecules within the display region are driven by an electric field formed between the first pixel electrodes PEₙ₋₁ and PEₙ in adjacent columns. In other words, the present disclosure includes a design approach of determining the voltage to be applied to the pixel electrode PEₙ in the n-th column based on the voltage to be applied to the pixel electrode PEₙ₋₁ in the (n−1)th column as a reference, thereby performing display with a predetermined gray scale value on a display portion 100 of the pixel in the n-th column. This approach may specifically include a procedure in which a circuitry configured to convert a video signal into an output signal from a source driver, for example, performs the following computation: when the maximum voltage applicable to the pixel electrodes is defined as Aₘₐₓ(V), the voltage that produces the gray scale value in a video signal for display in the pixel in the n-th column is defined as Bₙ(V), the voltage to be applied to the first pixel electrode in the (n−1)th column is defined as Cₙ₋₁(V), and the voltage to be applied to the first pixel electrode in the n-th column is defined as Cₙ(V), then the circuitry determines Cₙ based on the equation Cₙ=Cₙ₋₁+B₁ when Cₙ₋₁+B₁≤Aₘₐₓ, and based on the equation Cₙ=Cₙ₋₁−B₁ when Cₙ₋₁+B₁>Aₘₐₓ. Such a driving method enables display similar to that on IPS-mode liquid crystal display devices, without using a common electrode. With no common electrode for forming lateral electric field provided, the approach enables a higher definition while maintaining a sufficient aperture ratio.

Hereinbelow, an embodiment implementing the liquid crystal display device of the present disclosure is described with reference to the drawings. Here, the same reference signs are used across different drawings to denote the same or functionally similar components, and repeated descriptions thereof are omitted as appropriate.

### Embodiment 1

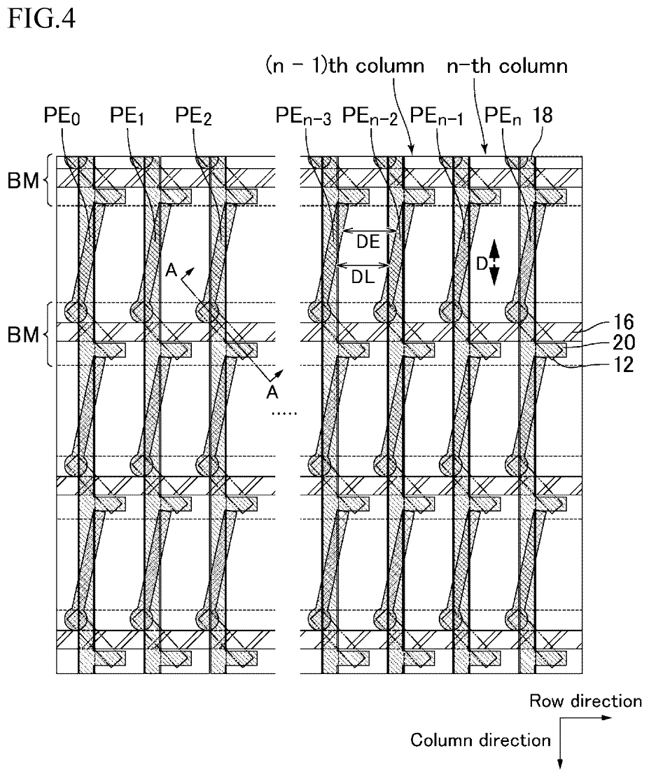

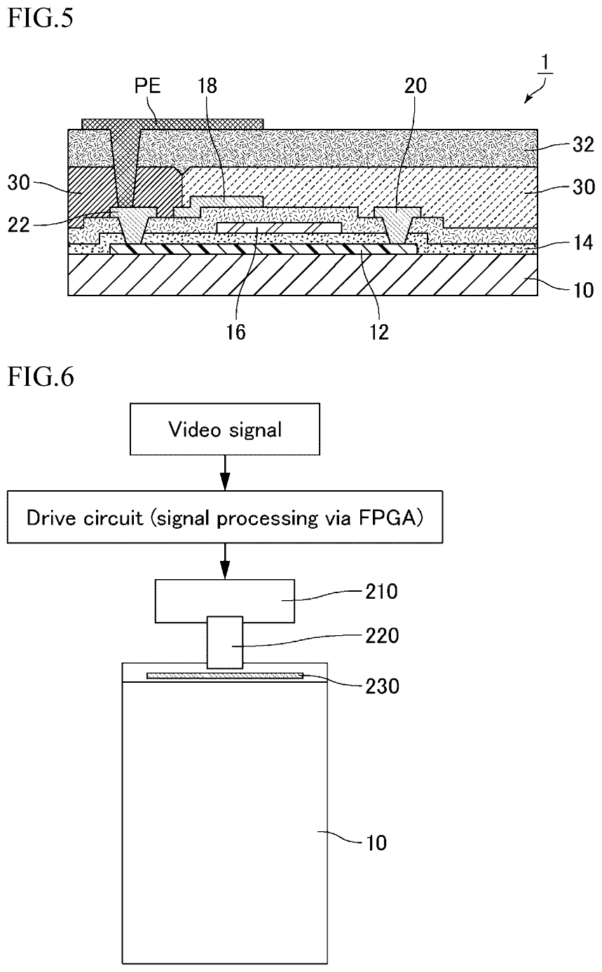

The configuration of a liquid crystal display device of Embodiment 1 is described with reference to FIGS. 4 to 6. FIG. 4 is a plan view schematically showing the pixel structure of a liquid crystal display device of Embodiment 1. FIG. 5 is a diagram schematically showing a cross section of an array substrate taken along the line A-A in FIG. 4. FIG. 6 is a diagram showing the system configuration of the liquid crystal display device of Embodiment 1. In the liquid crystal display device of Embodiment 1, pixels are arranged in a matrix of M rows and N columns (M and N are each an integer of 2 or greater). In the present disclosure, the term “pixel” may be any element corresponding to a display unit that constitutes the screen of a liquid crystal display device, and may be a “subpixel”.

The liquid crystal display device of Embodiment 1 includes a liquid crystal layer (now shown) including a liquid crystal material (liquid crystal molecules). The liquid crystal material exhibits nematic liquid crystallinity within a certain temperature range.

The liquid crystal layer is held between two substrates that face each other. Polarizers are disposed on the surfaces of the respective two substrates remote from the liquid crystal layer, which is held between the substrates. Changing the alignment of the liquid crystal molecules between the polarizers enables control of the amount of light passing through the liquid crystal layer. One of the two substrates holding the liquid crystal layer in between corresponds to an array substrate 1, and the other corresponds to a counter substrate.

The array substrate 1 includes non-linear elements arranged in a regular pattern (element arrays), signal lines that supply signals to the non-linear elements, and scanning lines that drive the non-linear elements. In the present embodiment, thin film transistors (TFTs) are arranged in a regular pattern as the non-linear elements on a first substrate 10, source bus lines 18 are provided as signal lines that supply voltages based on video signals to the non-linear elements, and gate bus lines 16 are provided as scanning lines that drive the non-linear elements. The TFTs each include three electrodes, namely a gate electrode which is part of a corresponding gate bus line 16, a source electrode 20 branched from a corresponding source bus line 18, and a drain electrode 22, and a semiconductor layer 12.

The gate electrode (gate bus line 16) and the semiconductor layer 12 are electrically insulated by a gate insulator 14. When the TFT is in the off state, the source electrode 20 and the drain electrode 22 are electrically separated from each other by the semiconductor layer 12, while when the TFT switches to the on state upon detecting a scanning signal supplied to its gate electrode, the source electrode 20 and the drain electrode 22 are electrically connected to each other by the semiconductor layer 12. An insulating layer consisting of a color filter layer 30 and an organic planarization film 32 is provided as an upper layer of the TFTs. On the insulating layer, (M×N) first pixel electrodes PE and M second pixel electrodes PE₀ are provided. The insulating layer is provided with through holes (also referred to as “contact holes”). The drain electrode 22 of each TFT is electrically connected to a corresponding first pixel electrode PE or second pixel electrode PE₀ via a corresponding through hole. The second pixel electrodes PE₀ may have the same structure as or a different structure from the first pixel electrodes PE.

In the present disclosure, the term “first pixel electrode PE” refers to all of the M×N first pixel electrodes or any first pixel electrode(s) among the M×N first pixel electrodes. First pixel electrodes in the x-th column (x represents any integer) are denoted by “first pixel electrodes PEx”.

The first pixel electrodes PE are provided within the display region (region where the pixels are arranged) and each correspond to one of the pixels. The first pixel electrodes PE are arranged in rows from the first row to the M-th row in the column direction and in columns from the first column to the N-th column in the row direction. In the present disclosure, the column direction corresponds to the direction in which the source bus lines 18 extend.

Column numbers shall be assigned to the columns from one end to the other end in the row direction of the display region; for example, the columns may be numbered sequentially from the left end or from the right end. The “first column” may refer to the left end column or the right end column in the row direction. Similarly, row numbers shall be assigned to the rows from one end to the other end in the column direction of the display region.

FIG. 4 shows, among the first pixel electrodes PE, first pixel electrodes PE₁ in the first column, first pixel electrodes PE₂ in the second column, first pixel electrodes PEₙ in the n-th column (n is an integer of 2 or greater and satisfies the relationship n<N), first pixel electrodes PEₙ₋₁ in the (n−1)th column, first pixel electrodes PEₙ₋₂ in the (n−2)th column, and first pixel electrodes PEₙ₋₃ in the (n−3)th column. In the cases of liquid crystal display devices performing color display using color filters of three colors, namely red (R), green (G), and blue (B), for example, the pixels with the first pixel electrodes PEₙ in the n-th column, the pixels with the first pixel electrodes PEₙ₋₁ in the (n−1)th column, and the pixels with the first pixel electrodes PEₙ₋₂ in the (n−2)th column may respectively correspond to R sub-pixels, G sub-pixels, and B sub-pixels.

The second pixel electrodes PE₀ are arranged adjacent to M first pixel electrodes PE₁ in the first column, and are located on a side opposite to first pixel electrodes PE₂ in the second column with respect to the first pixel electrodes PE₁ in the first column in the row direction. The second pixel electrodes PE₀ are distinguished from the first pixel electrodes PE in that driving signals generated from video signals are not input.

Application of voltages to the first pixel electrodes PE and the second pixel electrodes PE₀ enables a change in the alignment of the liquid crystal molecules. The application of voltages to the first pixel electrodes PE and the second pixel electrodes PE₀ is controlled by the later-described controller.

The first pixel electrodes PE preferably have a linear shape with no branched portion in order to increase the pixel definition. The linear shape refers to a shape with a ratio of the length to the width of 3 or more. The first pixel electrodes PE in FIG. 4 have a shape of a single line, excluding the through holes. The first pixel electrodes PE having a linear shape with no branched portion may each include a wide portion due to the presence of a through hole or may have a bent end.

The angle formed between the first direction in which a main portion including a central portion of each of the first pixel electrodes PE having a linear shape extends and the direction in which the source bus lines 18 extend is preferably 15° or less, more preferably 5° or less. This can increase the pixel aperture ratio to increase the transmittance (because the inclination of the molecules upon application of an electric field to the liquid crystal approaches 90 degrees), and also can reduce or prevent light leakage during black display (because interference between the incident polarized light and the edges of the first pixel electrodes PE can be reduced or prevented), thereby increasing the display contrast ratio.

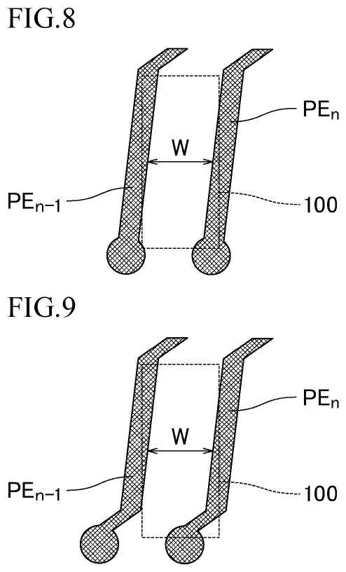

The first pixel electrodes PE having a linear shape may each include a main portion including a central portion thereof and extending in the first direction, and a bent portion connected to at least one of the end portions of the main portion in the first direction and extending in the second direction. The angle formed between the second direction and the direction in which the source bus lines extend is preferably greater than the angle formed between the first direction and the direction in which the source bus lines extend. In the end portions of the electrodes, the electric field lines become distorted, which may destabilize the moving direction of the liquid crystal molecules upon application of an electric field to the liquid crystal, thereby decreasing the response speed. Still, the structure described above (which exhibits the effect of accelerating the response in portions with the structure) can reduce or prevent the decrease in response speed. FIG. 8 is a plan view schematically showing a first pixel electrode that includes a bent portion in one of the end portions of the electrode. FIG. 9 is a plan view schematically showing a first pixel electrode that includes bent portions in both of the end portions of the electrode. The first pixel electrodes PE having the shape shown in FIG. 4 may be replaced with first pixel electrodes PE having the shape shown in FIG. 8 or FIG. 9.

From the standpoint of increasing the aperture ratio, the first pixel electrodes PE each preferably have a large area of overlap with the corresponding source bus line 18. For example, 50% or more of the area of each first pixel electrode PE (or the area of the linear main portion) overlaps with the corresponding source bus line 18.

As shown in FIG. 4, the linear main portion of each first pixel electrode PE includes a first portion overlapping with the corresponding source bus line 18 and a second portion not overlapping with the source bus line 18. The second portion includes a portion protruding across one side of the corresponding source bus line 18 in the row direction (direction perpendicular to the direction in which the source bus lines 18 extend) and another portion protruding across the opposite side of the source bus line 18 in the row direction.

From the standpoints of an increase in aperture ratio and the processing accuracy, the distance DE between adjacent two first pixel electrodes PE is preferably 70% or more of the distance DL between adjacent two source bus lines 18, more preferably greater than (100% or more of) the distance DL between adjacent two source bus lines 18.

The first pixel electrodes PE and the second pixel electrodes PE₀ may be formed of a transparent conductive film. When the first pixel electrodes PE and the second pixel electrodes PE₀ are formed of a transparent conductive film, the light-shielding portions separating the pixels that are arranged in the row direction in FIG. 4 are defined only by the source bus lines 18, which facilitates the increase in aperture ratio.

Either or both of the first pixel electrodes PE and the second pixel electrodes PE₀ may include a light-shielding material such as a metal film. With this structure, color mixing resulting from the overlap of light components transmitted through adjacent pixels when the array substrate 1 is observed from an oblique direction can be prevented by either or both of the first pixel electrodes PE and the second pixel electrodes PE₀, thereby effectively preventing color mixing of display light components in the liquid crystal display device.

In a plan view, between the source electrode 20 and the drain electrode 22 in a TFT, a source bus line 18 connected to the TFT is disposed.

The counter substrate includes a black matrix BM extending in the row direction to face the gate bus lines 16 in the array substrate 1 in a plan view. The black matrix BM of the present embodiment is not a grid-shaped black matrix and does not include parts extending in the column direction.

The liquid crystal display device of Embodiment 1 includes a controller. The controller includes a drive circuit and a source driver 230. After video signals are converted to driving signals by the controller, the driving signals are supplied to the first pixel electrodes PE. Specifically, video signals input from outside the liquid crystal display device via a wired or wireless communication device are input to the drive circuit in the circuit board. The drive circuit uses a field programmable gate array (FPGA) to perform signal processing and generate driving signals suitable for the driving method in the present disclosure, which does not include a common electrode. The drive circuit and the source driver 230 are electrically connected via a connector 210 and a flexible printed wiring board 220. The source driver 230 is located in a frame region of the liquid crystal display device, and is electrically connected to the drive circuit and the signal lines (source bus lines 18) of the array substrate 1. The driving signals generated by the drive circuit are output from the source driver 230 and supplied to the first pixel electrodes PE through the source bus lines 18 of the array substrate 1. As a result, voltages based on the video signals are applied to the first pixel electrodes PE.

Next, the driving method of the liquid crystal display device of Embodiment 1 is described.

In the present embodiment, M second pixel electrodes PE₀ are electrically connected to a signal line capable of applying a predetermined voltage, and the predetermined voltage is applied to drive the liquid crystal molecules within the display region. To the first pixel electrodes PE, driving signals generated from video signals (voltages based on the video signals) are supplied. The driving signals are adjusted such that the pixels perform display with the intended gray scale values based on the video signals.

To control display of the pixel in the m-th row and the first column (m is an integer of 1 or greater and M or less), the controller applies a predetermined voltage to the M second pixel electrodes PE₀ and a voltage based on a video signal to the first pixel electrode PE₁ in the m-th row and the first column. An electric field is formed between the first pixel electrode PE₁ in the m-th row and the first column and the second pixel electrode PE₀ adjacent to the first pixel electrode PE₁ in the row direction, which drives the liquid crystal molecules belonging to the pixel in the m-th row and the first column, performing display with the intended gray scale value.

To control display of the pixel in the m-th row and the n-th column (n is an integer of 2 or greater and N or less), the controller applies voltages based on video signals to the first pixel electrode PEₙ in the m-th row and the n-th column and to the first pixel electrode PEₙ₋₁ in the m-th row and the (n−1)th column. An electric field is formed between the first pixel electrode PEₙ in the m-th row and the n-th column and the first pixel electrode PEₙ₋₁ in the m-th row and the (n−1)th column, which drives the liquid crystal molecules belonging to the pixel in the m-th row and the n-th column, performing display with the intended gray scale value.

Such a driving method can drive the liquid crystal layer in a horizontal alignment mode without using a common electrode, enabling a higher definition while maintaining a sufficient aperture ratio.

The second pixel electrodes PE₀ are utilized to apply the reference voltage (predetermined voltage) for determining the voltage that drives the pixel in the m-th row and the first column. The structure of the second pixel electrodes PE₀ is not limited as long as the second pixel electrodes PE₀ are each located adjacent to a corresponding first pixel electrode PE₁ in the m-th row and the first column and to which a predetermined voltage is applied. The structure may be completely the same as the structure of the first pixel electrodes PE in the first and subsequent columns. The voltage applied to the second pixel electrodes PE₀ may not be a voltage determined based on a video signal, and can be set to any voltage that can be output from the source driver 230. The predetermined voltage applied to the second pixel electrodes PE₀ is a preset constant voltage such as, for example, a voltage of −6 V or more and 6 V or less. The predetermined voltage applied to the second pixel electrodes PE₀ may be maintained at a constant level, or the constant value may be changed at predetermined intervals. For example, the constant value may be changed between a positive filed and a negative field within a single frame. The second pixel electrodes PE₀ may have the same configuration as the first pixel electrodes PE. The signal line to which the second pixel electrodes PE₀ are connected may be any signal line that can apply a predetermined voltage, and may be the same signal line (source bus line 18) as those used for the first pixel electrodes PE. In this case, the non-linear elements and the second pixel electrodes PE₀ may be electrically connected via through holes.

The second pixel electrodes PE₀ have a shape similar to that of the first pixel electrodes PE, and preferably have substantially the same shape, more preferably the same shape, as the first pixel electrodes PE. The closer the shape of the second pixel electrodes PE₀ and the shape of the first pixel electrodes PE in the first column, the easier it is to match the pattern of electric fields formed between the second pixel electrodes PE₀ and the first pixel electrodes PE in the first column and the pattern of electric fields formed between the first pixel electrodes PE in the first column and the first pixel electrodes PE in the adjacent subsequent column.

The controller may determine the voltage to be applied to the first pixel electrode PE in the m-th row and the first column based on the gray scale value for display in the pixel in the m-th row and the first column using the predetermined voltage as a reference, and may determine the voltage to be applied to the first pixel electrode PE in the m-th row and the n-th column based on the gray scale value for display in the pixel in the m-th row and the n-th column using the voltage to be applied to the first pixel electrode PE in the m-th row and the (n−1)th column. This can drive the liquid crystal layer in a horizontal alignment mode while utilizing the second pixel electrodes PE₀. The gray scale value for display in the pixel in the m-th row and the first column and the gray scale value for display in the pixel in the m-th row and the n-th column are included as data in the video signals.

When the maximum voltage applicable to the first pixel electrodes PE is defined as Aₘₐₓ(V), the minimum voltage applicable to the first pixel electrodes PE is defined as Aₘᵢₙ (V), the voltage that produces the gray scale value for display in the pixel in the m-th row and the n-th column is defined as Bₙ(V), the voltage to be applied to the first pixel electrode PE in the m-th row and the (n−1)th column is defined as Cₙ₋₁(V), and the voltage to be applied to the first pixel electrode PE in the m-th row and the n-th column is defined as Cₙ(V), the controller may determine Cₙ(V) based on either one of the following equations (1) and (2) or either one of the following equations (3) and (4).

$$if {C}_{n - 1} + {B}_{n} \leq {A}_{max} , then {C}_{n} = {C}_{n - 1} + {B}_{n} \qquad Equation ( 1 )$$

$$if {C}_{n - 1} + {B}_{n} > {A}_{max} , then {C}_{n} = {C}_{n - 1} - {B}_{n} \qquad Equation ( 2 )$$

$$if {C}_{n - 1} - {B}_{n} \geq {A}_{min} , then {C}_{n} = {C}_{n - 1} - {B}_{n} \qquad Equation ( 3 )$$

$$if {C}_{n - 1} - {B}_{n} < {A}_{min} , then {C}_{n} = {C}_{n - 1} + {B}_{n} \qquad Equation ( 4 )$$

The above processing can implement the driving method in the present disclosure while preventing the maximum applicable voltage Aₘₐₓ from increasing excessively and the minimum applicable voltage Aₘᵢₙ from decreasing excessively. The maximum applicable voltage Aₘₐₓ is set to +4 V or more and +8 V or less, for example. The minimum applicable voltage Aₘᵢₙ is set to −8 V or more and −4 V or less, for example. The voltage B (B₁, Bₙ) refers to a voltage to be applied to the liquid crystal layer to cause the liquid crystal layer to exhibit a transmittance corresponding to the gray scale value for display in each pixel, with 0 V as a reference. In the driving method in the present disclosure not including a common electrode, the voltage to be applied to the liquid crystal layer at the pixel in the m-th row and the n-th column equals the difference in electric potential between the voltage Cₙ to be applied to the first pixel electrode PEₙ in the n-th column and the voltage Cₙ₋₁ to be applied to the first pixel electrode PEₙ₋₁ in the (n−1)th column. The controller therefore determines Cₙ(V) based on any one of the equations (1) to (4).

When a positive predetermined voltage to be applied to the second pixel electrodes PE₀ is defined as D₁(V), a negative predetermined voltage to be applied to the second pixel electrodes PE₀ is defined as D₂(V), the voltage that produces the gray scale value for display in the pixel in the m-th row and the first column is defined as B₁ (V), and the voltage to be applied to the first pixel electrode in the m-th row and the first column is defined as C₁(V), the controller may determine C₁(V) based on either one of the following equations (5) and (6) or either one of the following equations (7) and (8).

$$if {D}_{1} + {B}_{1} \leq {A}_{max} , then {C}_{1} = {D}_{1} + {B}_{1} \qquad Equation ( 5 )$$

$$if {D}_{1} + {B}_{1} > {A}_{max} , then {C}_{1} = {D}_{1} - {B}_{1} \qquad Equation ( 6 )$$

$$if {D}_{2} - {B}_{1} \geq {A}_{min} , then {C}_{1} = {D}_{2} - {B}_{1} \qquad Equation ( 7 )$$

$$if {D}_{2} - {B}_{1} < {A}_{min} , then {C}_{1} = {D}_{2} + {B}_{1} \qquad Equation ( 8 )$$

The above processing can implement the driving method in the present disclosure while preventing the maximum applicable voltage Aₘₐₓ from increasing excessively and the minimum applicable voltage Aₘᵢₙ from decreasing excessively.

The controller may be configured to drive the M second pixel electrodes PE₀ and the first pixel electrode in the m-th row and the first column with an AC voltage by inverting the polarity of the predetermined voltage between a positive field and a negative field within a single frame. This enables application of a substantially AC electric field to the liquid crystal layer while utilizing the second pixel electrodes PE₀ in the driving method in the present disclosure. The driving with an AC voltage is performed, for example, such that a positive field during which a positive voltage is applied to the second pixel electrodes PE₀ and a negative field during which a negative voltage is applied to the second pixel electrodes PE₀ are included in a single frame that constitutes one screen.

The controller may be configured to drive the first pixel electrode in the m-th row and the n-th column with an AC voltage by determining Cₙ(V) during the positive field in a single frame using either one of the equations (1) and (2) and determining Cₙ(V) during the negative field in the single frame using either one of the equations (3) and (4). For example, when the maximum applicable voltage Aₘₐₓ is +a (V), the minimum applicable voltage Aₘᵢₙ may be −a (V). This can render the voltages applied to the liquid crystal layer during the positive field and the negative field symmetric.

In the liquid crystal display device of Embodiment 1, a constant DC component may be superimposed on each of the voltages to be applied to the first pixel electrodes PE. This can compensate for the voltage fluctuation that is caused by parasitic capacitance (Cgd) when the gate voltage of each pixel TFT switches from ON to OFF, thereby reducing or preventing flicker during display. When the voltage fluctuation is denoted by ΔVp, the ON/OFF difference in gate voltage is denoted by Vg, the capacitance of the pixel liquid crystal is denoted by Clc, and the pixel parasitic capacitance is denoted by Cs, the following equation holds: ΔVp=Vg×Cgd/(Cgd+Clc+Cs). To compensate for the voltage fluctuation, preferably, a DC component corresponding to ΔVp is applied to the liquid crystal. In the present driving method, no common electrode is provided, so that a DC component is applied to the first pixel electrodes PE. Even if the DC component is not applied, flicker would be less visible as the driving frequency of the pixels increases (for example, 120 Hz). Still, the applied voltages would remain asymmetric, and thus a DC component is preferably superimposed on the voltages. A typical liquid crystal display device employs N-type semiconductors in pixel TFTs, meaning that the voltage fluctuation caused by parasitic capacitance tends to shift in the negative direction. In this case, the DC component is to be superimposed in the positive direction. The voltage of the DC component is typically about +0.1 to +0.2 V.

One aspect of the present disclosure provides a liquid crystal display device in which a predetermined voltage is applied to the second pixel electrodes, and another aspect of the present disclosure provides a liquid crystal display device in which the first pixel electrodes have a linear shape with no branched portion. In other words, the liquid crystal display device of the present disclosure may have a configuration in which the predetermined voltage is not applied to the second pixel electrodes as long as the first pixel electrodes have a linear shape with no branched portion.

### EXAMPLES

The following describes examples as specific examples of the liquid crystal display device of the present disclosure. However, the present invention is not limited to these examples.

### Example 1

In Example 1, the liquid crystal display device of Embodiment 1 was actually produced according to the following procedure. The liquid crystal display device produced in Example 1 is specifically described with reference to FIGS. 4 to 6. The liquid crystal display device produced in Example 1 was assumed to operate as a TFT-LCD for HMDs with a resolution of about 1700 ppi. The size of each pixel was set to 15×15 μm, and the size of each color sub-pixel was set to 5×15 μm.

### (1) Production of Array Substrate

TFTs each including a gate electrode (gate bus line 16), a gate insulator 14, and a semiconductor layer 12 formed of IGZO, which is an oxide semiconductor, and other components were formed on a first substrate 10. The width of source bus lines 18, which has a large influence on the aperture ratio, was set to 1.5 μm.

Next, colored organic resists were used to form red, green, and blue color filters defining a color filter layer 30, which was then coated with an organic material to form an organic planarization film (overcoat layer) 32. The organic planarization film 32 rendered the surface of the workpiece flat.

Subsequently, the color filter layer 30 and the organic planarization film 32 were patterned with openings for through holes, on which a transparent conductive film was then deposited. Thereby, first pixel electrodes PE connected to the drain electrodes 22 of the corresponding TFTs via the through holes were formed. The first pixel electrodes PE were formed into a linear shape with no branched portion, in a plan view. Additionally, an alignment film was formed by coating, and subjected to an alignment treatment in a direction that forms an angle of 5° with the extension direction of the linear first pixel electrodes PE (alignment treatment in the direction indicated by the arrow D in FIG. 4).

Thereby, an array substrate 1 was completed.

### (2) Production of Liquid Crystal Display Device

On a second substrate, a black matrix was formed only in the row direction (direction parallel to the gate bus lines 16), and an alignment film was further formed, followed by an alignment treatment in the same alignment direction as that for the alignment film in the array substrate 1. Thereby, a counter substrate was completed.

Next, the array substrate 1 and the counter substrate were bonded together with a liquid crystal layer interposed between them, polarizing plates were bonded, the drivers and the drive circuits were connected, and the resulting cell was coupled with a backlight system. Thereby, a liquid crystal display device was produced.

### (3) Driving of Liquid Crystal Display Device

The drive circuits performed signal processing using an FPGA to convert a video signal into a driving signal. In the signal processing, a source driver 230 had a maximum applicable voltage of 5 V and a minimum applicable voltage of −5 V.

Regarding the pixel in the m-th row and the first column (m is an integer of 1 or greater), a positive predetermined voltage to be applied to the second pixel electrodes PE₀ during a positive field in a single frame was defined as D₁(V), a negative predetermined voltage to be applied to the second pixel electrodes PE₀ during a negative field in the single frame was defined as D₂(V), the voltage that produces a gray scale value for display in the pixel in the m-th row and the first column was defined as B₁(V), and the voltage to be applied to the first pixel electrode in the m-th row and the first column was defined as C₁ (V). Then, during the positive field, C₁(V) was determined by computing the equation C₁=D₁+B₁ if D₁+B₁≤5 V or the equation C₁=D₁−B₁ if D₁+B₁>5 V During the negative field, Cₙ(V) was determined by computing the equation C₁=D₂−B₁ if D₂−B₁≥−5 V or the equation C₁=D₂+B₁ if D₂−B₁<−5 V.

Regarding the pixel in the m-th row and the n-th column (n is an integer of 2 or greater), the voltage that produces a gray scale value for display in the pixel in the m-th row and the n-th column was defined as Bₙ(V), the voltage to be applied to the first pixel electrode PEₙ₋₁ in the m-th row and the (n−1)th column was defined as Cₙ₋₁ (V), and the voltage to be applied to the first pixel electrode PEₙ in the m-th row and the n-th column was defined as Cₙ(V). Then, during the positive filed, Cₙ(V) was determined by computing the equation Cₙ=Cₙ₋₁+B₁ if Cₙ₋₁+Bₙ≤5 V or the equation Cₙ=Cₙ₋₁−Bₙ if Cₙ₋₁+Bₙ>5 V During the negative field, Cₙ(V) was determined by computing the equation Cₙ=Cₙ₋₁−Bₙ if Cₙ₋₁−B₁≥−5 V or the equation Cₙ=Cₙ₋₁+Bₙ if Cₙ₋₁−Bₙ<−5 V.

### (4) Evaluation of Liquid Crystal Display Device Characteristics

The liquid crystal display device of Example 1 exhibited a transmittance about 1.6 times higher than the transmittance, as predicted by the simulation, of an FFS-LCD capable of performing display with appropriate gray scale values and having the same resolution.

### Example 2

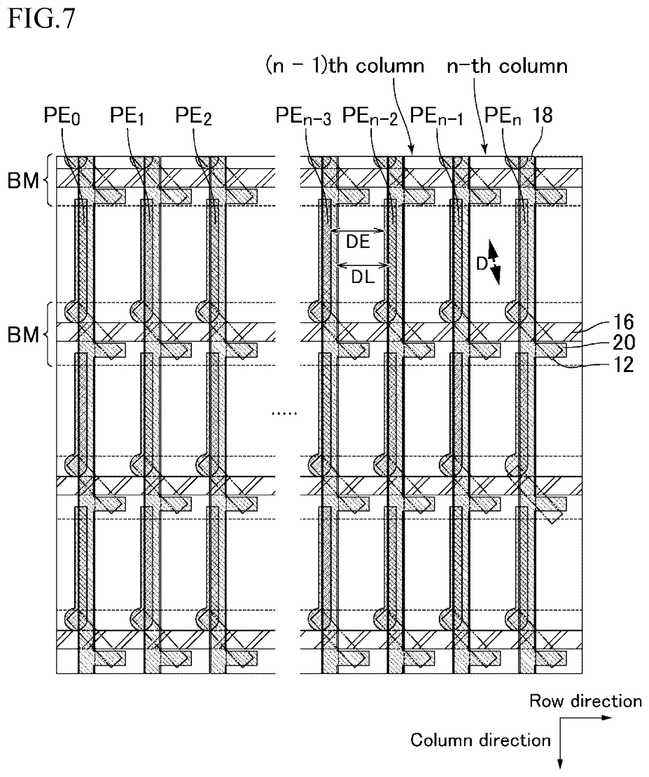

FIG. 7 is a plan view schematically showing the pixel structure of a liquid crystal display device of Example 2. While the first pixel electrodes PE were formed at an angle relative to the source bus lines 18 in Example 1, the first pixel electrodes PE were parallel to the source bus lines 18 in Example 2. In Example 2, descriptions of the features that are common with Example 1 are omitted.

As shown in FIG. 7, the linear main portion of each first pixel electrode PE includes a first portion overlapping with the corresponding source bus line 18 and a second portion not overlapping with the source bus line 18. The second portion protrudes across one side of the corresponding source bus line 18 in the row direction (direction perpendicular to the direction in which the source bus lines 18 extend).

For both the array substrate and the counter substrate, an alignment treatment was performed in an alignment direction at an angle relative to the first pixel electrodes PE (the direction indicated by the arrow D in FIG. 7). The alignment treatment directions for the array substrate and the counter substrate were the same when the substrates were observed from front after they were bonded together.

Although the first pixel electrodes PE are desirably thinner than the source bus lines 18, the first pixel electrodes PE were formed wider than the desired width due to the issues related to processing accuracy. Since the first pixel electrodes PE are transparent, the width of the openings in the pixels equals the space between the source bus lines 18. In Example 2, the transmittance was 5 to 10% higher than that in Example 1.

Preferably, the absorption axis of each polarizing plate is set according to the alignment azimuth of the liquid crystal. When polarized light is incident on the liquid crystal panel at an angle that is neither perpendicular nor parallel to the alignment azimuth of the liquid crystal and strikes the edge of a metal pattern such as the source bus lines 18, the light is slightly depolarized due to interference or scattering, which may result in light leakage. This may lead to a decrease in display contrast ratio.

### Modified Example

While an FPGA was used as each drive circuit in Examples 1 and 2, the drive circuit may be an integrated circuit.

The first pixel electrodes PE may be formed of a transparent conductive film such as an ITO film or an IZO film, or may be formed of a light-shielding material such as a metal film to prevent color mixing in oblique observations.

The color filter layer 30 may be formed in the counter substrate. An insufficient degree of bonding accuracy between the array substrate 1 and the counter substrate may result in an insufficient aperture ratio.

The signal processing performed by the controller (drive circuits) includes computations that are adjustable depending on the driving method. The processing may be in any of the following embodiments, for example.

[1] The electric potential of the voltage applied to the second pixel electrodes PE₀ may be 0, or the polarity may be inverted for each field of driving. For example, the voltage may be −5 V during an odd-numbered field and +5 V during an even-numbered field.

[2] In order to make the electric fields applied to the liquid crystal layer into AC components, the signs of the signal processing equations may be inverted for each field by, for example, using either one of the equations (3) and (4) and either one of the equations (7) and (8) during an odd-numbered field and using either one of the equations (1) and (2) and either one of the equations (5) and (6) during an even-numbered field.

[3] Due to the parasitic capacitance of the TFTs and other factors, a DC component may appear in the signals applied to the liquid crystal layer. Thus, a constant bias (DC component) may be applied to all the driving signals applied to the source electrodes 20.

[4] In order to increase the response speed of the liquid crystal molecules, a driving method (overshoot driving) may be employed that includes applying, for a short period of time, a voltage higher than or lower than the voltage that can produce a gray scale value for display in each pixel. The overshoot driving can be implemented using look-up tables in combination with computations.

What is claimed is:

1. A liquid crystal display device comprising:
a plurality of pixels arranged in a matrix of M rows and N columns, wherein M and N are each an integer of 2 or greater;
an array substrate including:
a plurality of first pixel electrodes being disposed respectively in the plurality of pixels; and
M second pixel electrodes respectively arranged adjacent to M first pixel electrodes in a first column among the plurality of first pixel electrodes, located on a side opposite to first pixel electrodes in a second column with respect to the first pixel electrodes in the first column in a row direction;
a liquid crystal layer including liquid crystal molecules; and
a controller configured to apply a predetermined voltage to the M second pixel electrodes and voltages based on video signals to the plurality of first pixel electrodes to drive:
liquid crystal molecules belonging to a pixel in an m-th row and a first column, wherein m is an integer of 1 or greater and M or less, using an electric field formed between a first pixel electrode in the m-th row and the first column among the plurality of first pixel electrodes and a second pixel electrode located adjacent in the row direction to the first pixel electrode in the m-th row and the first column among the M second pixel electrodes; and
liquid crystal molecules belonging to a pixel in the m-th row and an n-th column, wherein n is an integer of 2 or greater and N or less, using an electric field formed between a first pixel electrode in the m-th row and the n-th column and a first pixel electrode in the m-th row and an (n−1)th column among the plurality of first pixel electrodes.

2. The liquid crystal display device according to claim 1,
wherein the controller is configured to determine the voltage to be applied to the first pixel electrode in the m-th row and the first column based on a gray scale value for display in the pixel in the m-th row and the first column using the predetermined voltage as a reference, and to determine the voltage to be applied to the first pixel electrode in the m-th row and the n-th column based on a gray scale value for display in the pixel in the m-th row and the n-th column using the voltage to be applied to the first pixel electrode in the m-th row and the (n−1)th column as a reference.

3. The liquid crystal display device according to claim 2,
wherein when a maximum voltage applicable to the plurality of first pixel electrodes is defined as Aₘₐₓ(V), a minimum voltage applicable to the plurality of first pixel electrodes is defined as Aₘᵢₙ(V), a voltage that produces the gray scale value for display in the pixel in the m-th row and the n-th column is defined as Bₙ(V), a voltage to be applied to the first pixel electrode in the m-th row and the (n−1)th column is defined as Cₙ₋₁(V), and a voltage to be applied to the first pixel electrode in the m-th row and the n-th column is defined as Cₙ(V),
the controller is configured to determine Cₙ(V) based on either one of the following equations (1) and (2) or either one of the following equations (3) and (4):
$$if {C}_{n - 1} + {B}_{n} \leq {A}_{max} , then {C}_{n} = {C}_{n - 1} + {B}_{n} \qquad Equation ( 1 )$$
$$if {C}_{n - 1} + {B}_{n} > {A}_{max} , then {C}_{n} = {C}_{n - 1} - {B}_{n} \qquad Equation ( 2 )$$
$$if {C}_{n - 1} - {B}_{n} \geq {A}_{min} , then {C}_{n} = {C}_{n - 1} - {B}_{n} \qquad Equation ( 3 )$$
$$if {C}_{n - 1} - {B}_{n} < {A}_{min} , then {C}_{n} = {C}_{n - 1} + {B}_{n} . \qquad Equation ( 4 )$$

4. The liquid crystal display device according to claim 2,
wherein the controller is configured to drive the M second pixel electrodes and the first pixel electrode in the m-th row and the first column with an AC voltage by inverting a polarity of the predetermined voltage between a positive field and a negative field within a single frame.

5. The liquid crystal display device according to claim 3,
wherein the controller is configured to drive the first pixel electrode in the m-th row and the n-th column with an AC voltage by determining Cₙ(V) during a positive field within a single frame based on either one of the equations (1) and (2) and determining Cₙ(V) during a negative field within the single frame based on either one of the equations (3) and (4).

6. The liquid crystal display device according to claim 1,
wherein a constant DC component is superimposed on each of the voltages to be applied to the plurality of first pixel electrodes.

7. The liquid crystal display device according to claim 1,
wherein the second pixel electrodes have substantially a same shape as the first pixel electrodes.

8. The liquid crystal display device according to claim 1,
wherein the first pixel electrodes have a linear shape with no branched portion.

9. The liquid crystal display device according to claim 8,
wherein the array substrate further includes a source bus line to which the voltages based on the video signals are supplied, and
an angle formed between a first direction in which a main portion including a central portion of each of the first pixel electrodes extends and a direction in which the source bus line extends is 15° or less.

10. The liquid crystal display device according to claim 8,
wherein the array substrate further includes a source bus line to which the voltages based on the video signals are supplied,
the first pixel electrodes each include a main portion including a central portion thereof and extending in a first direction, and a bent portion connected to at least one of end portions of the main portion in the first direction and extending in a second direction, and
an angle formed between the second direction and a direction in which the source bus line extends is greater than an angle formed between the first direction and the direction in which the source bus line extends.

11. The liquid crystal display device according to claim 1,
wherein either or both of the first pixel electrodes and the second pixel electrodes include a light-shielding material.

12. A liquid crystal display device comprising:
a plurality of pixels arranged in a matrix of M rows and N columns, wherein M and N are each an integer of 2 or greater;
an array substrate including:
a plurality of first pixel electrodes being disposed respectively in the plurality of pixels; and
M second pixel electrodes respectively arranged adjacent to M first pixel electrodes in a first column among the plurality of first pixel electrodes, located on a side opposite to first pixel electrodes in a second column with respect to the first pixel electrodes in the first column in a row direction;
a liquid crystal layer including liquid crystal molecules; and
a controller configured to apply a voltage to the M second pixel electrodes and voltages based on video signals to the plurality of first pixel electrodes to drive:
liquid crystal molecules belonging to a pixel in an m-th row and a first column, wherein m is an integer of 1 or greater and M or less, using an electric field formed between a first pixel electrode in the m-th row and the first column among the plurality of first pixel electrodes and a second pixel electrode located adjacent in the row direction to the first pixel electrode in the m-th row and the first column among the M second pixel electrodes; and
liquid crystal molecules belonging to a pixel in the m-th row and an n-th column, wherein n is an integer of 2 or greater and N or less, using an electric field formed between a first pixel electrode in the m-th row and the n-th column and a first pixel electrode in the m-th row and an (n−1)th column among the plurality of first pixel electrodes,
the plurality of first pixel electrodes having a linear shape with no branched portion.

13. The liquid crystal display device according to claim 12,
wherein the array substrate further includes a source bus line to which the voltages based on the video signals are supplied, and
an angle formed between a first direction in which a main portion including a central portion of each of the first pixel electrodes extends and a direction in which the source bus line extends is 15° or less.

14. The liquid crystal display device according to claim 12,
wherein the array substrate further includes a source bus line to which the voltages based on the video signals are supplied,
the first pixel electrodes each include a main portion including a central portion thereof and extending in a first direction, and a bent portion connected to at least one of end portions of the main portion in the first direction and extending in a second direction, and
an angle formed between the second direction and a direction in which the source bus line extends is greater than an angle formed between the first direction and the direction in which the source bus line extends.

15. The liquid crystal display device according to claim 12,
wherein either or both of the first pixel electrodes and the second pixel electrodes include a light-shielding material.
